(19) United States
(12) Patent Application Publication
(10) Pub. No.: US 2005/0197840 A1
(43) Pub. Date: Sep. 8, 2005

(54) Device for event prediction on booting a motherboard

(75) Inventors: Chin-Hsiang Wang, Hsinchu City (TW); Shing Ming Miaw, Hsintien (TW); Pei Chuan Liang, Hsinchu City (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 11/064,839

(22) Filed: Feb. 25, 2005

(30) Foreign Application Priority Data
Mar. 5, 2004 (TW) 093105861

(51) Int. Cl. G06F 9/00

(52) U.S. Cl. 704/260

(57) ABSTRACT

An event predictor on a motherboard has a storage device, a date filter, a text analyzer, and a speech database. The storage device stores an event table containing a plurality of events. The date filter is connected to the storage device for receiving date information provided by the motherboard such that data of today associated event field is extracted by reading the event table from the storage device when the motherboard is booting. The text analyzer is connected to the date filter for converting data of today associated event field into a text data. The speech database stores a plurality of characters in a form of speech data for proceeding to search and match based on the text data, thereby outputting a sequence of corresponding speech data.

### BACKGROUND OF THE INVENTION

1. Field of the Invention

The invention relates to an event-reminding device on booting a motherboard and, more particularly, to a computer virus (referred to as a virus) event prediction device capable of automatically reporting virus messages on booting a motherboard.

2. Description of Related Art

FIG. 1 shows a block diagram of a personal computer (PC). In FIG. 1, the PC includes a processor 110, a northbridge chip 120, a southbridge chip 130, an AC 97 Codec 140, a BIOS (basic input/output system) 150 and a speaker 170. The BIOS 150 is connected to the southbridge chip 130 through an LPC bus 160. When the PC is playing music, the processor 110 executes associated settings to send music data to the Codec 140 for playing, or the Codec 140 directly reads music data for playing.

In the aforementioned PC configuration, during the time after booting the motherboard and before entering an operating system (OS), the processor 110 is busy to execute various tests and settings on the motherboard. For example, memory test, memory and IO address tests and settings in various PCI cards on the PCI bus, keyboard and mouse tests are executing during the time, which need a lot of computation power of the processor 110, so that a user can do nothing but waiting in front of the PC.

Therefore, it is desirable to provide an improved device for event reminding when booting a motherboard to mitigate and/or obviate the aforementioned problems.

### SUMMARY OF THE INVENTION

The object of the invention is to provide an event-reminding device when booting a motherboard, which can automatically report coming event messages when the motherboard is booting.

In order to accomplish the object of the invention mentioned above, an event-reminding device is provided. The device includes a storage device, a date filter, a text analyzer and a speech database. The storage device stores an event table containing a plurality of events. The date filter is connected to the storage device for receiving date information provided by the motherboard such that data of today associated event field is extracted by reading the event table from the storage device when the motherboard is booting. The text analyzer is connected to the date filter for converting the data of today associated event field into a text data. The speech database stores a plurality of speech data of text, for proceeding to search and match to the text data of the text analyzer, thereby outputting a sequence of corresponding speech data.

Other objects, advantages, and novel features of the invention will become more apparent from the following detailed description when taken in conjunction with the accompanying drawings.

### BRIEF DESCRIPTION OF THE DRAWINGS

FIG. 1 is a hardware block diagram of a typical personal computer (PC);

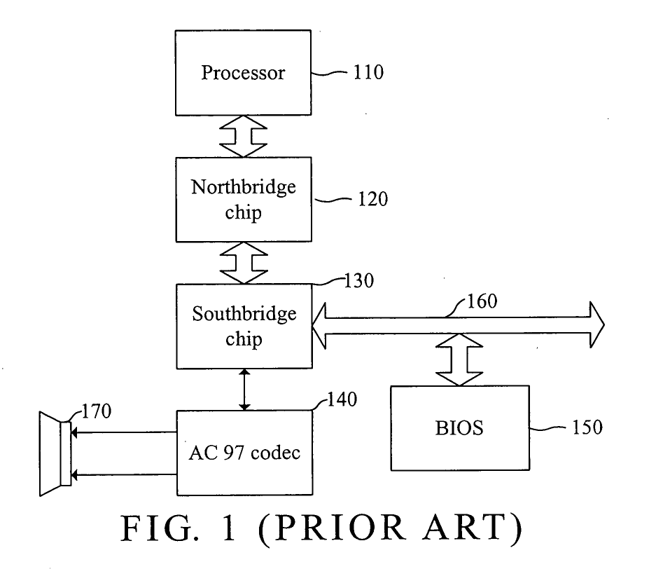

FIG. 2 is a block diagram of an event prediction device on booting a motherboard in accordance with the invention;

FIG. 3 is a schematic of an application of FIG. 2 in accordance with the invention;

FIG. 4 is a content of a storage device in accordance with the invention; and

FIG. 5 is a flowchart of updating the content of FIG. 4 in accordance with the invention.

### DETAILED DESCRIPTION OF THE PREFERRED EMBODIMENT

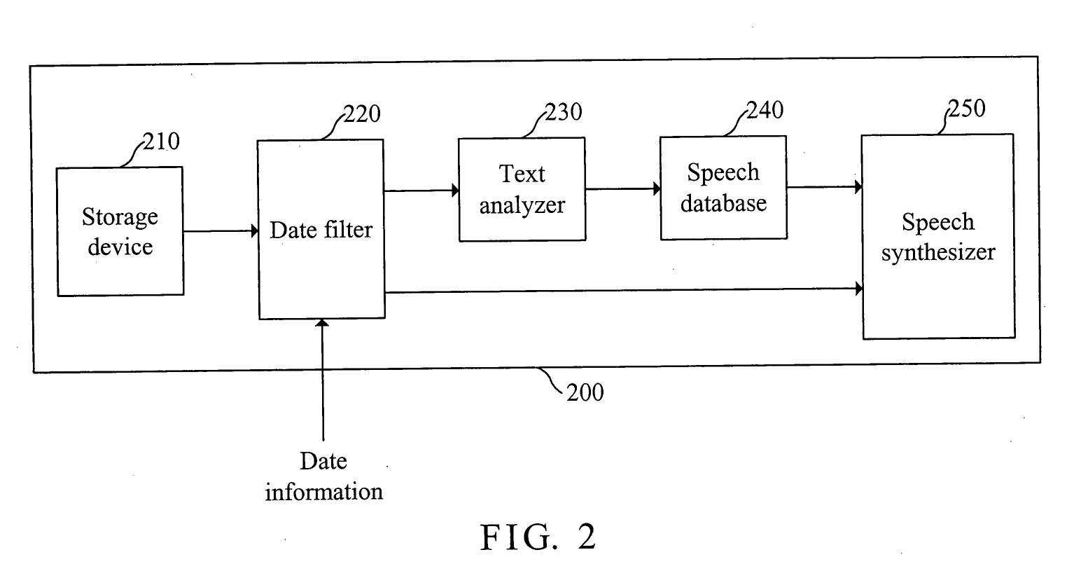

FIG. 2 is a block diagram of an event-reminding device 200 on booting a motherboard in accordance with the invention. As shown, the device 200 comprises a storage device 210, a date filter 220, a text analyzer 230, a speech database 240 and a speech synthesizer 250. The storage device 210 stores an event table containing a plurality of events. Because the event table needs to be updated frequently, the storage device 210 is preferably a flash memory to repeatedly read and write. The date filter 220 is connected to the storage device 210 for receiving date information provided by the motherboard. The event field data of current day is extracted by reading the event table from the storage device 210 when the motherboard is booting.

The text analyzer 230 is connected to the date filter 220 for converting the data of today associated event field into a text data to output. The speech database 240 stores a plurality of characters in a form of speech data of text, for proceeding to search and match with the text data outputted by the text analyzer 230, thereby outputting a sequence of corresponding speech data. The speech synthesizer 250 is connected to the speech database 240 and the date filter 220 for synthesizing the speech data as a sound data to play.

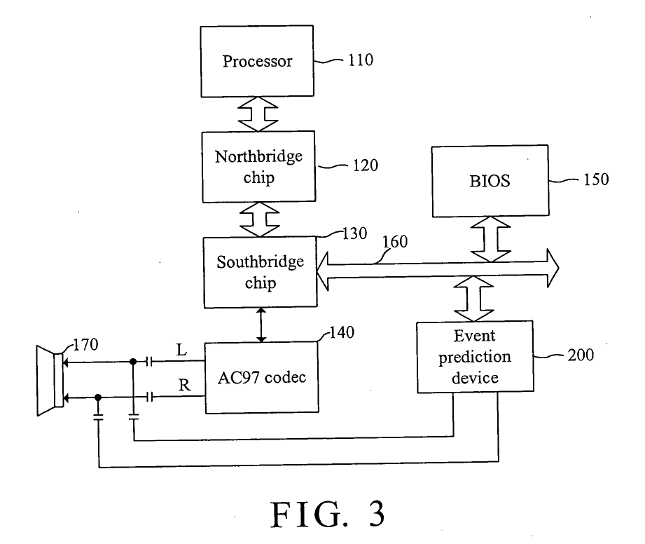

FIG. 3 is a schematic diagram of an application of FIG. 2 in accordance with the invention. As shown, the event-reminding device 200 is connected to a southbridge chip 130 on the motherboard through a bus 160. The bus 160 can be a PLC or I2C bus. The device 200 outputs a two-channel sound signal to a speaker 170. Since the processor 110 is busy in various tests and settings of the motherboard, the processor 110 cannot play any music through the AC97 Codec 140. During the time period, after booting the motherboard and before entering the operating system, the inventive device 200 can thus drive the speaker 170 through the two-channel sound signal.

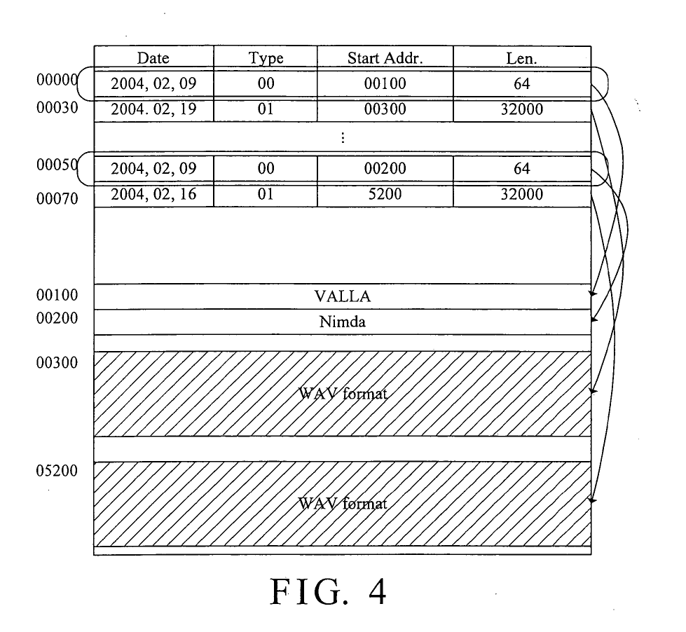

When booting the motherboard, the date filter 220 reads an event table from the storage device 210. FIG. 4 shows a relation of fields of the event table and stored data of the storage device 210. For an exemplary description, virus data stored in address 000000 of the storage device 210 has fields of Date, Type, Start Addr. and Len. The Date field records corresponding date of virus or event appearance. The Type field records data type of corresponding event record. For example, 00 indicates a text file, 01 indicates a voice file with a format of WAV or MP3. The Start Addr. field records the start address of corresponding virus or event. The Len. field records the length of name of corresponding virus or event. The first virus data of the event table in FIG. 4 records a PE_VALLA.A virus, a text file, to be appeared on Feb. 9, 2004, name of which is stored by a length of 64 bytes starting with address 00100 of the storage device 210.

If a user powers on the computer on Feb. 9, 2004, the date filter 220 receives date information provided by the motherboard and reads the event table from the storage device 210 in order to extract data fields of VALLA and Nimda viruses appeared on Feb. 9, 2004 and send the data fields extracted to the text analyzer 230.

The text analyzer 230 receives the data fields of VALLA and Nimda viruses sent by the date filter 220 and accordingly determines the type field received as a text to output. The speech database 240 receives the text and accordingly searches and matches internal characters stored in a form of speech data, thereby outputting a sequence of corresponding speech data. The speech synthesizer 250 is connected to the speech database 240 and the date filter 220 for synthesizing the speech data outputted as a sound data and sending the sound data to the speaker 170 through the two-channel sound signal line, thereby playing corresponding data of event of today when the motherboard is booting.

The Start Addr. field of the event table can alternately record a speech data of corresponding virus and the Len. field records a length of the speech data. For example, address 00030 in FIG. 4 records a virus to be appeared on Feb. 19, 2004, in a voice file stored by a length of 32000 bytes starting with address 00300. If a user powers on the computer on Feb. 9, 2004, the date filter 220 extracts the event table from the storage device 210 and accordingly determines corresponding data of the virus as a speech data, thus the speech data is directly sent to the speech synthesizer and further the speaker 170 can sound data of event of today.

The Start Addr. field of the event table can alternately record an event's speech data such as text and speech data of essential meeting prompt, calendar, birthday, festival, to do list, or a date of today. The Len. field records a length of the speech data. The Type field records data type of the event recorded. For example, 00 indicates a text file, 01 indicates a voice file with a format of WAV or MP3. In FIG. 4, for example, address 00070 of the event table records an event occurred on Feb. 16, 2004, in a voice file stored by a length of 32000 bytes starting with address 05200 of the storage device 210. If a user powers on the computer on Feb. 16, 2004, the date filter 220 reads the event table from the storage device 210 and accordingly determines corresponding data of the event as a speech data, thus the speech data is directly sent to the speech synthesizer and further the speaker 170 can play the data of event of today.

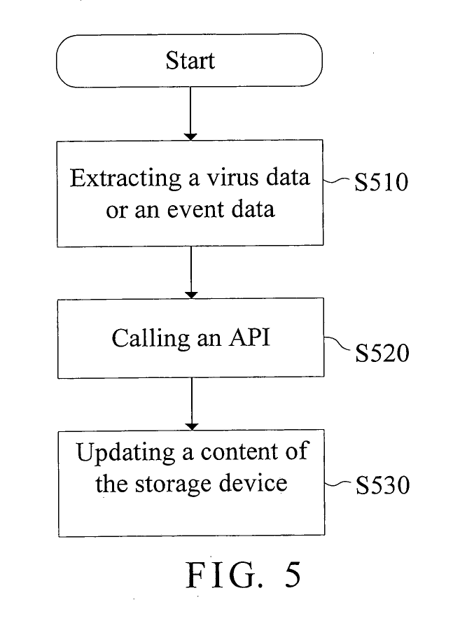

For accurate operation, the event table and corresponding data frequently needs to be updated as shown in a flowchart of FIG. 5. As shown in FIG. 5, firstly, a program is executed as entering an operating system after the motherboard is booting, thereby extracting a virus data from the Internet or an event data from a calendar (step S510). Step S520 then calls an API that is provided by the operating system for writing the virus or event data in the storage device 210. Step S530 finally updates a content of the storage device 210 as the virus or event data written is complete.

In view of the foregoing description, the invention applies an event reminding device 200 for playing data of virus of today to be appeared or data of user calendar of today when the computer is power-on, thus the idle time of power-on can be sufficiently utilized in preventing viruses to be appeared from data losses, even out of work.

Although the present invention has been explained in relation to its preferred embodiment, it is to be understood that many other possible modifications and variations can be made without departing from the spirit and scope of the invention as hereinafter claimed.

1. A device for event reminding when booting a motherboard, comprising:
a storage device, which stores an event table containing a plurality of events;
a date filter, which is connected to the storage device for receiving date information provided by the motherboard such that when the motherboard is booting, data of event field of today is extracted by reading the event table from the storage device, and identify the data of event is text data or voice data;
a text analyzer, which is connected to the date filter for converting the data of event field of today into a text data;
a speech database, which stores a plurality of characters in a form of speech data, for proceeding to search and match with the text data converted by the text analyzer, thereby outputting a sequence of corresponding speech data.

2. The device as claimed in claim 1, further comprising a speech synthesizer connected to the speech database and the date filter for synthesizing the speech data as a sound data to play.

3. The device as claimed in claim 1, wherein the event table records virus data as a text file.

4. The device as claimed in claim 2, wherein the event table records virus data as a sound file.

5. The device as claimed in claim 4, wherein when virus data extracted by the date filter is a sound file, the speech synthesizer is connected to the date filter for directly playing the sound file.

6. The device as claimed in claim 1, further comprising an LPC bus connecting the device to a southbridge chip on the motherboard.

7. The device as claimed in claim 1, further comprising an I2C bus connecting the device to a southbridge chip on the motherboard.

8. The device as claimed in claim 1, wherein the storage device further stores text or sound data of calendars, birthdays, festivals, to do list, meeting schedules, greetings and advertisements.
